(19) United States
(12) Patent Application Publication
(10) Pub. No.: US 2011/0225074 A1
(43) Pub. Date: Sep. 15, 2011

(54) SYSTEM AND METHOD FOR PROVIDING INFORMATION AS A SERVICE VIA WEB SERVICES

(75) Inventors: Moe Khosravy, Bellevue, WA (US); Christian Liensberger, Bellevue, WA (US); Lukasz Gwozdz, Seattle, WA (US); Greg Swedberg, Bellevue, WA (US); Roger Soulen Mall, Sammamish, WA (US); Rene Bouw, Kirkland, WA (US)

(73) Assignee: MICROSOFT CORPORATION, Redmond, WA (US)

(21) Appl. No.: 12/818,371

(22) Filed: Jun. 18, 2010

Related U.S. Application Data
(60) Provisional application No. 61/313,324, filed on Mar. 12, 2010.

(51) Int. Cl. G06F 9/46; G06F 3/048; G06F 17/30; G06Q 30/00; G06Q 50/00

(52) U.S. Cl. 705/34; 719/328; 715/810; 707/769; 707/E17.014

(57) ABSTRACT

Aspects are disclosed for providing information as a service via web services. Access to at least one application programming interface (API) database is facilitated and requests for a requested API are parsed. Here, such API requests facilitate a processing of data provided by at least one content provider. In an aspect, each request includes a key associated with a developer of the requested API and a unique identifier associated with a user of the requested API. A usage of the requested API is then tracked based on the key and/or unique identifier.

### CROSS-REFERENCE TO RELATED APPLICATION

This application claims the benefit of U.S. Provisional Patent Application Ser. No. 61/313,324, filed Mar. 12, 2010, which is titled “SYSTEM AND METHOD FOR PROVIDING INFORMATION AS A SERVICE VIA WEB SERVICES,” and the entire contents of which are incorporated herein by reference.

### BACKGROUND

I. Field

The following description relates generally to web services, and more particularly to systems and methods for providing information as a service via web services.

II. Background

By way of background concerning some conventional systems, computing devices have traditionally stored information and associated applications and data services locally to the device. Yet, with the evolution of on-line and cloud services, information is increasingly being moved to network providers who perform none, some or all of the services on behalf of devices. The evolution of network storage farms capable of storing terabytes of data (with potential for petabytes, exabytes, etc. of data in the future) has created an opportunity to mimic the local scenario in a cloud, with separation of the primary device and the external storage.

However, no cloud service or network storage provider has been able to effectively provide information as a service on any platform, with publishers, developers, and consumers easily publishing, specializing applications for and consuming any kind of data, in a way that can be tracked and audited for all involved. In addition, due to the disparate number of content providers and their typically proprietary schemas for defining data, today, where disparate content providers do not coordinate their acts with respect to the cloud directly with one another, there is little opportunity to properly map data transaction flow in a way that is fair to everyone in the transaction chain. In effect, from the publishers to the developers to the consuming audience, such as subscribers, different views over the transactions have different shapes and meanings due to imbalanced information across the transaction chain.

To this end, today's systems for providing access to information from a cloud have various shortcomings when it comes to use and widespread adoption. For instance, conventional infrastructures do not allow seamless consumption of data across disparate platforms. In cases where disparate platforms are involved, application programming interfaces (APIs) are sometimes vital components for bridging such communication gap. However, current methods for tracking API usage lack automation, which makes auditing and/or billing API usage particularly difficult. As a result, API owners are often discouraged from releasing APIs into the public.

The above-described deficiencies of current methods are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure thereof, various aspects are described in connection with providing information as a service from any platform. In one such aspect, an apparatus configured to facilitate providing information as a service via web services is disclosed. Within such embodiment, the apparatus includes a processor configured to execute computer executable components stored in memory. The computer executable components include an interface component, a parsing component, and a tracking component. The interface component is configured to facilitate access to at least one application programming interface (API) database, whereas the parsing component is configured to parse a request for a requested API. For this embodiment, API requests facilitate a processing of data provided by at least one content provider. In an aspect, the request includes a key associated with a developer of the requested API and a unique identifier associated with a user of the requested API. The tracking component is then configured to track a use of the requested API based on the key and/or unique identifier.

Other embodiments and various non-limiting examples, scenarios and implementations are described in more detail below.

### BRIEF DESCRIPTION OF THE DRAWINGS

FIG. 1 is an overview of an exemplary system for providing information as a service via web services in accordance with an aspect of the subject specification.

FIG. 2 is an illustration of an exemplary API request according to an embodiment.

FIG. 3 illustrates a block diagram of an exemplary web servicing unit in accordance with an aspect of the subject specification.

FIG. 4 is an illustration of an exemplary coupling of components that effectuate processing API requests in accordance with an embodiment.

FIG. 5 is a flow chart illustrating an exemplary methodology for facilitating a processing API requests in accordance with an embodiment.

FIG. 6 is an illustration of an exemplary coupling of components that effectuate generating API requests in accordance with an embodiment.

FIG. 7 is a flow chart illustrating an exemplary methodology that facilitates generating API requests in accordance with an embodiment.

FIG. 8 is an illustration of an exemplary coupling of components that effectuate uploading APIs in accordance with an embodiment.

FIG. 9 is a flow chart illustrating an exemplary methodology that facilitates uploading APIs in accordance with an embodiment.

FIG. 10 is a flow diagram illustrating an exemplary sequence for a non-limiting infrastructure for information provided as a service from any platform.

FIG. 11 is a block diagram illustrating an exemplary non-limiting infrastructure for information provided as a service from any platform.

FIG. 12 is a block diagram illustrating an exemplary non-limiting set of implementation specific details for an infrastructure for information provided as a service from any platform.

FIG. 13 is illustrative of exemplary consumption of data from an exemplary infrastructure for information provided as a service from any platform.

FIG. 14 is a block diagram representing exemplary non-limiting networked environments in which various embodiments described herein can be implemented.

FIG. 15 is a block diagram representing an exemplary non-limiting computing system or operating environment in which one or more aspects of various embodiments described herein can be implemented.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

The subject specification discloses a system and method that facilitates providing information as a service via web services. In an aspect, a web services application programming interface (API) is provided for consuming data from a publishing base. Within such embodiment, each request for an API (e.g., Get_Weather ( ) specifies at least a developer key (for who developed the API), one or more unique identifiers (specifying user(s) who call the API), and any partner identifiers involved in API calls (e.g., a party affiliated with the API). By including these three components in each API request, tracking the web services APIs can be automated. Moreover, API usage can be automatically auditing, billed, and reported, which provides content owners with a powerful tool indicating how their data is being used and by whom. In an aspect, multi-seat API usage can also be tracked based on multiple unique identifiers specified for a group of individuals.

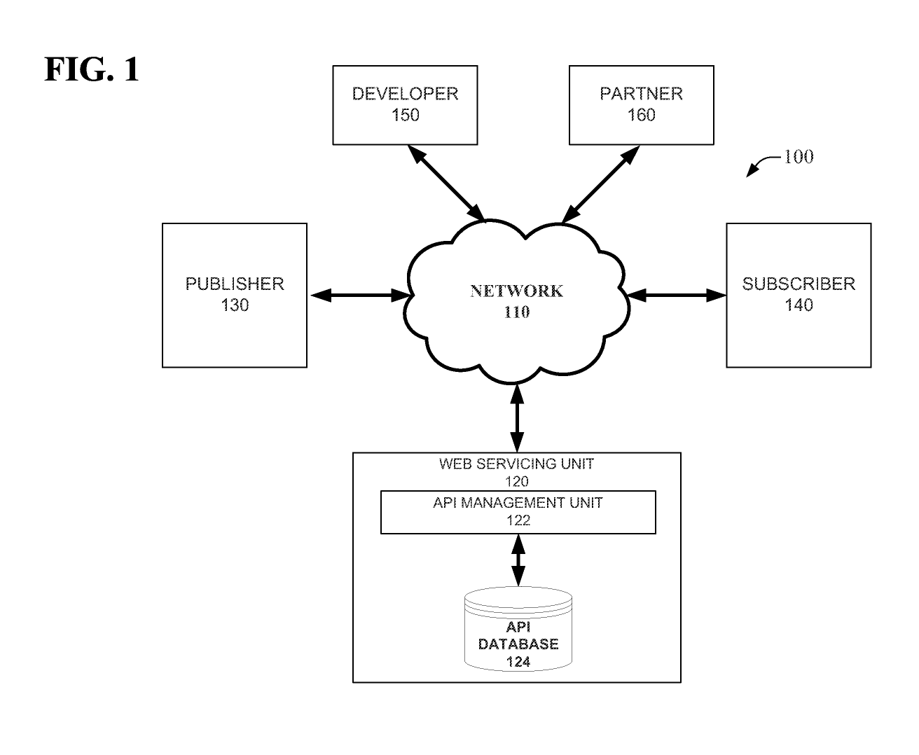

Referring next to FIG. 1, an overview of an exemplary system for providing information as a service via web services in accordance with an aspect is shown. As illustrated, system 100 includes web servicing unit 120, publisher 130, subscriber 140, developer 150, and partner 160, which are communicatively coupled via network 110. In an aspect, web servicing unit 120 facilitates providing information as a service by offering a centralized infrastructure for uploading and obtaining APIs, wherein API usage can be tracked seamlessly. For instance, subscriber 140 wishing to obtain content from publisher 130 may search API database 124 via API management unit 122 for a desired API (e.g., an API for retrieving weather data from a particular content provider). In an aspect, the selected API may have been uploaded onto API database 124 by partner 160 (e.g., NOKIA) and resold to subscriber 140 by developer 150 (e.g., an independent software vendor (ISV)). Within such embodiment, a usage of the selected API is tracked based on identifying parameters included in each API request.

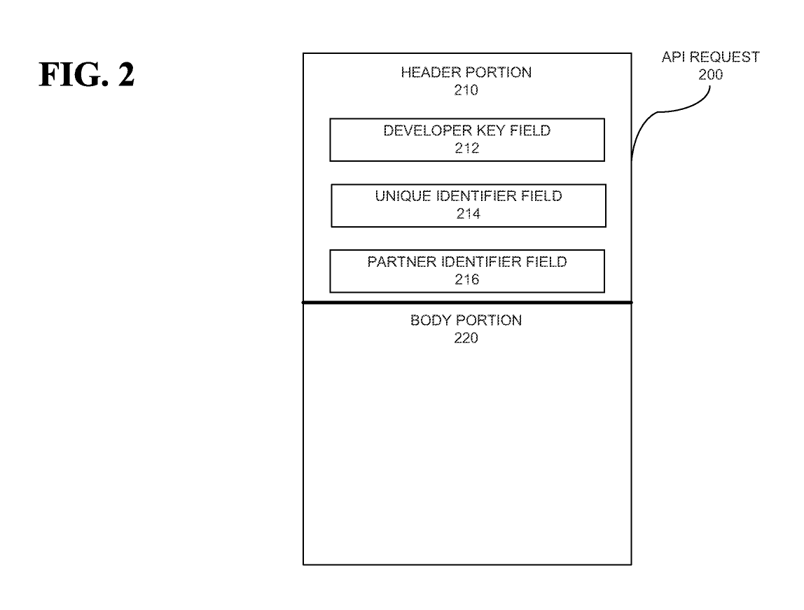

Referring next to FIG. 2, an exemplary API request is illustrated according to an embodiment. As shown, API request 200 may include a header portion 210 and a body portion 220. In an aspect, header portion 210 uniformly includes a developer key field 212, a unique identifier field 214, and a partner identifier field 216. For this embodiment, it should be appreciated that unique identifier field 214 may facilitate tracking multi-seat API usage by including a unique identifier for multiple users. Furthermore, with respect to partner identifier 216 it should be appreciated that a null value can be specified indicating that no partner is affiliated with a particular API request.

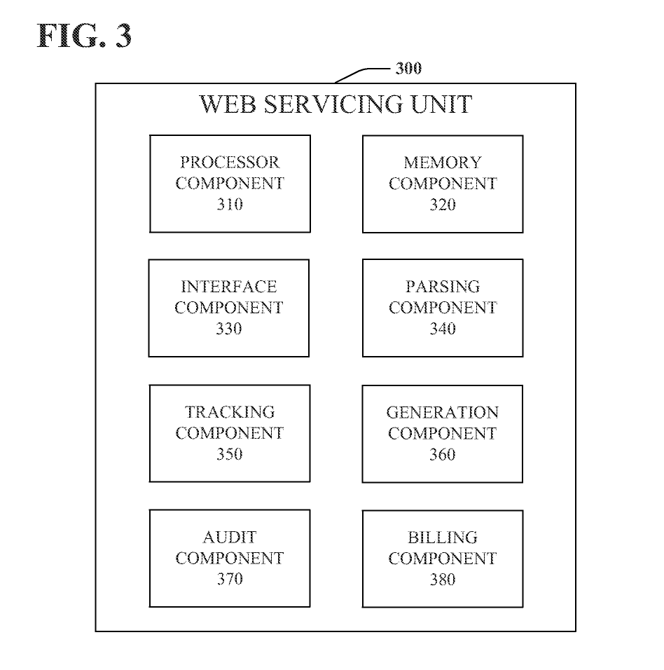

Referring next to FIG. 3, a block diagram of an exemplary web servicing unit that facilitates providing information as a service via web services is provided. As shown, web servicing unit 300 may include processor component 310, memory component 320, interface component 330, parsing component 340, tracking component 350, generation component 360, audit component 370, and billing component 380.

In one aspect, processor component 310 is configured to execute computer-readable instructions related to performing any of a plurality of functions. Processor component 310 can be a single processor or a plurality of processors dedicated to analyzing information to be communicated from web servicing unit 300 and/or generating information that can be utilized by memory component 320, interface component 330, parsing component 340, tracking component 350, generation component 360, audit component 370, and/or billing component 380. Additionally or alternatively, processor component 310 may be configured to control one or more components of web servicing unit 300.

In another aspect, memory component 320 is coupled to processor component 310 and configured to store computer-readable instructions executed by processor component 310. Memory component 320 may also be configured to store any of a plurality of other types of data including data generated by any of interface component 330, parsing component 340, tracking component 350, generation component 360, audit component 370, and/or billing component 380. Memory component 320 can be configured in a number of different configurations, including as random access memory, battery-backed memory, hard disk, magnetic tape, etc. Various features can also be implemented upon memory component 320, such as compression and automatic back up (e.g., use of a Redundant Array of Independent Drives configuration).

In yet another aspect, interface component 330 is also coupled to processor component 310 and configured to interface web servicing unit 300 with external entities. For instance, interface component 330 may be configured to facilitate access to an API database. In a particular embodiment, interface component 330 may be configured to facilitate uploading external APIs onto the API database and/or generating API requests for APIs stored in the API database. Indeed, within such embodiments, user-friendly interfaces can be implemented such as, for example, an API upload wizard and/or an API request wizard. For instance, interface component 330 may be configured to display to a user a plurality of selectable APIs stored in the API database. For this embodiment, interface component 330 can be further configured to facilitate a search of the API database, wherein the selectable APIs displayed to the user correspond to results of the search. Such a search can be based on a user input identifying any of a plurality of criteria including, for example, a desired operation (e.g., extract maximum/minimum, ascertain average value, etc.), a desired content provider (e.g., CNN, Fox News, etc.), and/or a desired content type (e.g., weather, stocks, etc.).

In a further embodiment, web servicing unit 300 may also include generation component 360. Within such embodiment, generation component 360 is coupled to interface component 330 and configured to generate the API requests based on an input. For example, in an aspect, generation component 360 may be configured to automatically generate an API request for a selected API. Moreover, upon receiving a selection of a particular API, generation component 360 may be configured to ascertain and/or generate a developer key, a unique identifier, and/or a partner identifier, which is/are then automatically inserted into an API request.

As illustrated, web servicing unit 300 may also include parsing component 340 and tracking component 350. In an aspect, upon receiving an API request, parsing component 340 is configured to parse the API request to extract each of a developer key (e.g., associated with a developer of the requested API), a unique identifier (e.g., associated with a user of the requested API), and a partner identifier (e.g., associated with a partner/affiliate of the requested API) from the request, whereas tracking component 350 is configured to track a use of the requested API based on at least one of the key, the unique identifier, or the partner identifier. In a further aspect, it should be appreciated that web servicing unit 300 may be configured to process API requests pertaining to a multi-seat use of the requested API. To facilitate processing such requests, parsing component 340 may be configured to extract multiple unique identifiers from the requested API, wherein the multiple unique identifiers respectively identify multiple users associated with a multi-seat use of the requested API. Tracking component 350 can then be configured to track this multi-seat use on a per-use and/or per-user basis according to the multiple unique identifiers.

In another aspect, web servicing unit 300 further includes audit component 370 and billing component 380, which are each coupled to tracking component 350. Within such embodiment, audit component 370 is configured to automatically audit a usage history of APIs within the API database, whereas billing component 380 is configured to automatically bill an external entity (e.g., a content owner, developer, partner, and/or user) based on such usage history.

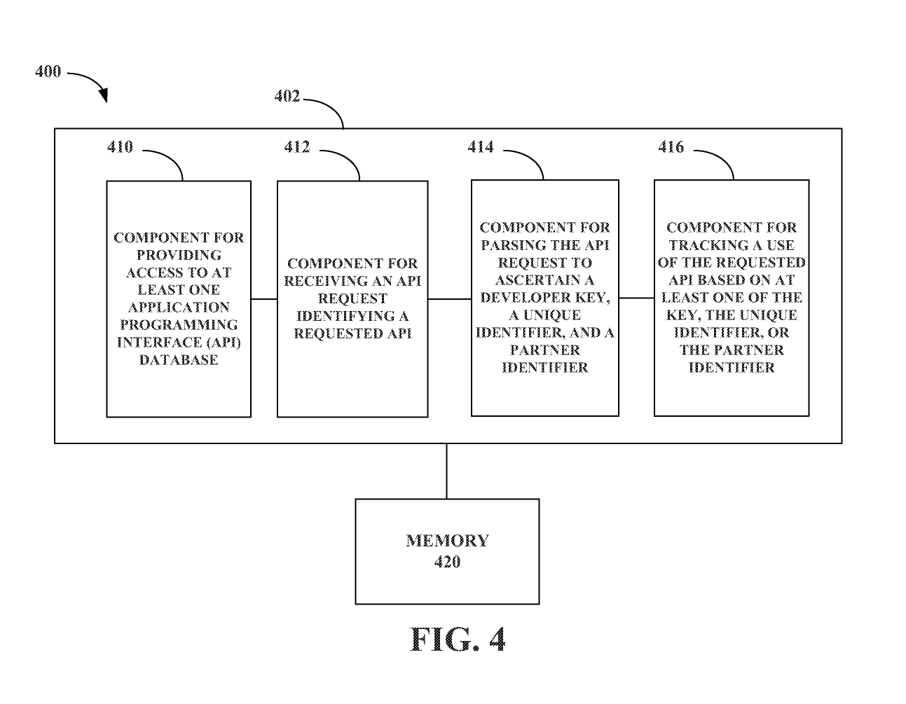

Turning to FIG. 4, illustrated is a system 400 that facilitates processing API requests according to an embodiment. System 400 and/or instructions for implementing system 400 can reside within web servicing unit 300 or a computer-readable storage medium, for instance. As depicted, system 400 includes functional blocks that can represent functions implemented by a processor, software, or combination thereof (e.g., firmware). System 400 includes a logical grouping 402 of components that can act in conjunction. As illustrated, logical grouping 402 can include a component for providing access to at least one API database 410, as well as a component for receiving an API request identifying a requested API 412. Logical grouping 402 can also include a component for parsing the API request to ascertain a developer key, a unique identifier, and a partner identifier 414. Further, logical grouping 402 can include a component for tracking a use of the requested API based on at least one of the key, the unique identifier, or the partner identifier 416. Additionally, system 400 can include a memory 420 that retains instructions for executing functions associated with components 410, 412, 414, and 416, wherein any of components 410, 412, 414, and 416 can exist either within or outside memory 420.

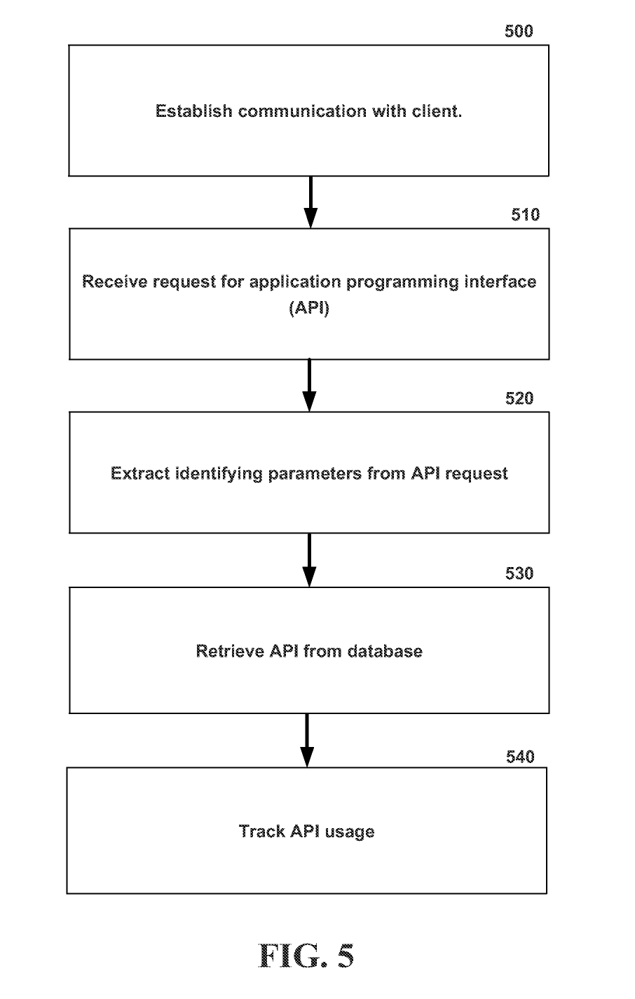

Referring next to FIG. 5, a flow chart illustrating an exemplary method that facilitates processing API requests according to an embodiment is provided. As illustrated, this method includes a series of acts that may be performed by a computing device according to an aspect of the subject specification. For instance, this method may be implemented by employing a processor to execute computer executable instructions stored on a computer readable storage medium to implement the series of acts. In another embodiment, a computer-readable storage medium comprising code for implementing the series of acts is contemplated.

As illustrated, the method begins by establishing a communication with a client device at act 500. For this particular example, the client may be associated with a developer (e.g., an ISV). Next, at act 510, a request for a particular API is received. Upon receiving the API request, identifying parameters embedded in the API request are then extracted at act 520. In an aspect, as stated previously, such parameters may include a developer key, a unique identifier, and a partner identifier.

After extracting the identifying parameters, the method proceeds by retrieving the requested API from an API database at act 530. Here, it should be appreciated that the requested API may have been similarly requested by any of various other ISVs. Accordingly, at act 540, the method proceeds by tracking a usage of the requested API, wherein such tracking facilitates automatic auditing/billing of the requested API (e.g., on a per use and/or per user basis according to the unique identifiers).

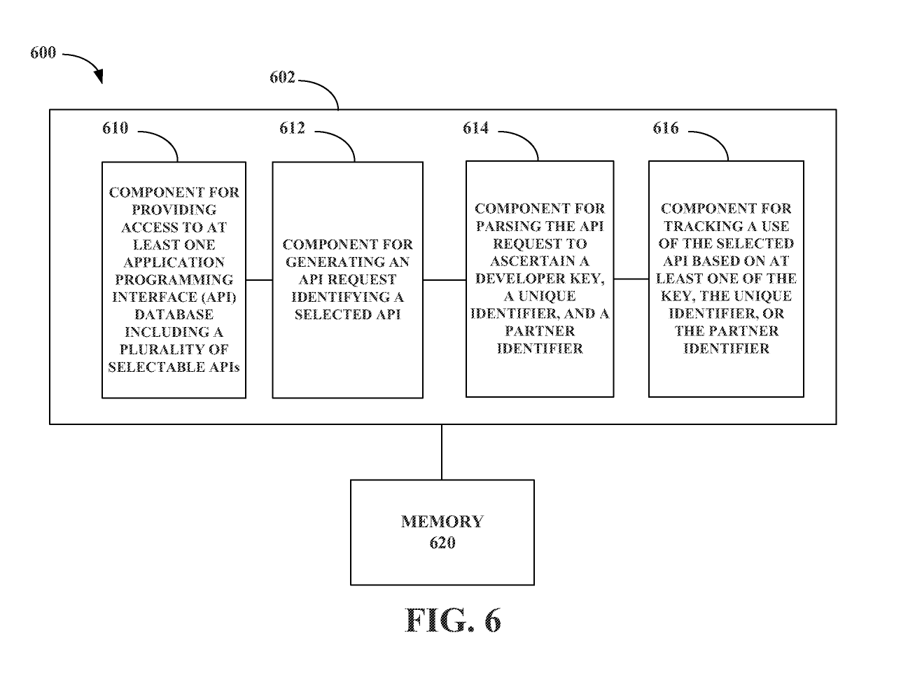

Referring next to FIG. 6, illustrated is a system 600 that facilitates generating API requests according to an embodiment. System 600 and/or instructions for implementing system 600 can reside within web servicing unit 300 or a computer-readable storage medium, for instance, wherein system 600 includes functional blocks that can represent functions implemented by a processor, software, or combination thereof (e.g., firmware). Moreover, system 600 includes a logical grouping 602 of components that can act in conjunction similar to logical grouping 402 in system 400. As illustrated, logical grouping 602 can include a component for providing access to at least one API database including a plurality of selectable APIs 610, as well as a component for generating an API request identifying a selected API 612. Logical grouping 602 can also include a component for parsing the API request to ascertain a developer key, a unique identifier, and a partner identifier 614. Further, logical grouping 602 can include a component for tracking a use of the selected API based on at least one of the key, the unique identifier, or the partner identifier 616. Additionally, system 600 can include a memory 620 that retains instructions for executing functions associated with components 610, 612, 614, and 616. While shown as being external to memory 620, it is to be understood that components 610, 612, 614, and 616 can exist within memory 620.

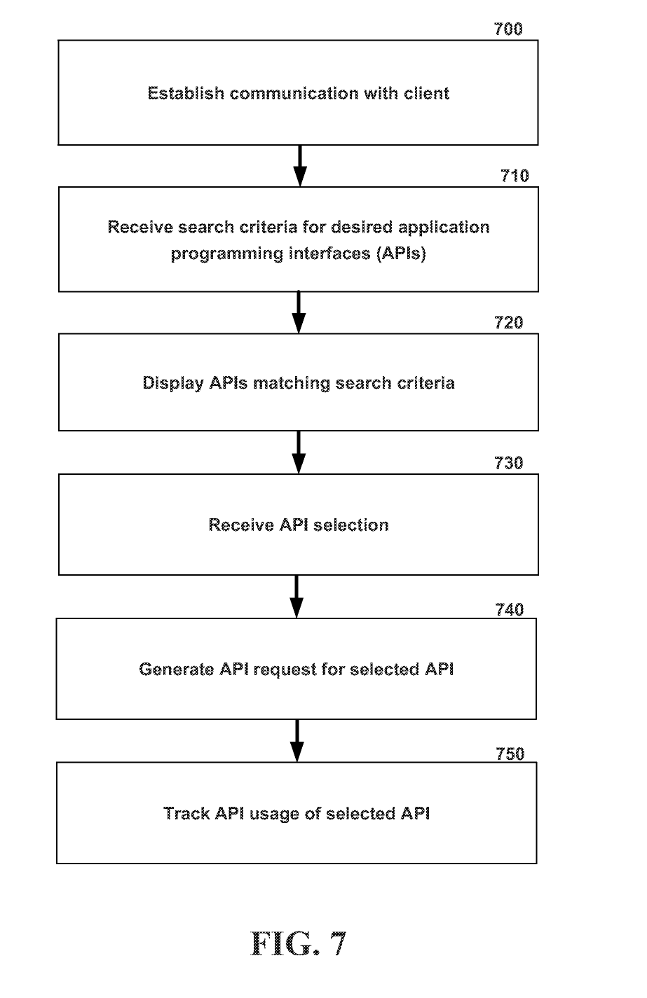

Referring next to FIG. 7, a flow chart illustrating an exemplary method that facilitates generating API requests according to an embodiment is provided. As illustrated, this method includes a series of acts that may be performed by a computing device according to an aspect of the subject specification. For instance, this method may be implemented by employing a processor to execute computer executable instructions stored on a computer readable storage medium to implement the series of acts. In another embodiment, a computer-readable storage medium comprising code for implementing the series of acts is contemplated.

As illustrated, the method begins by establishing a communication with a client device at act 700. For this particular example, the client may be associated with a user (e.g., an information worker). Next, at act 710, a search criteria input is received corresponding to particular APIs desired by the user. As stated previously, such an input may identify any of a plurality of criteria including, for example, a desired operation (e.g., extract maximum/minimum, ascertain average value, etc.), a desired content provider (e.g., CNN, Fox News, etc.), and/or a desired content type (e.g., weather, stocks, etc.). Upon receiving the search criteria input, a set of APIs matching the search criteria input are then displayed at act 720. An input is then received at act 730 identifying the particular API selected by the user.

Once an API is selected, the method proceeds by generating an API request for the selected API at act 740. In an aspect, generating the API request may include ascertaining and/or generating a developer key, a unique identifier, and/or a partner identifier, which is/are then automatically inserted into the API request. For multi-seat API usage, multiple unique identifiers respectively identifying multiple users of the API may be generated and subsequently inserted into the request.

Once the API request is generated, the API can be called. Here, however, it should be appreciated that the selected API may have been similarly called by any of various other users. Accordingly, at act 750, the method proceeds by tracking a usage of the selected API, wherein such tracking facilitates automatic auditing/billing of the selected API (e.g., on a per use and/or per user basis according to the unique identifiers).

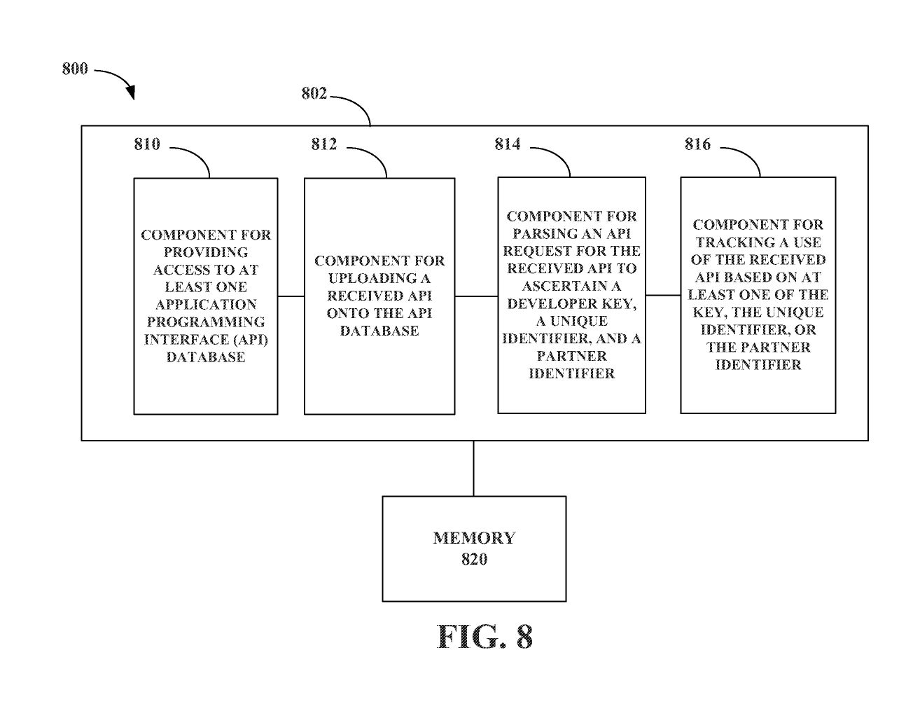

Referring next to FIG. 8, illustrated is a system 800 facilitates uploading APIs according to an embodiment. System 800 and/or instructions for implementing system 800 can reside within web servicing unit 300 or computer-readable storage medium, for instance, wherein system 800 includes functional blocks that can represent functions implemented by a processor, software, or combination thereof (e.g., firmware). Moreover, system 800 includes a logical grouping 802 of components that can act in conjunction similar to logical groupings 402 and 602 in systems 400 and 600, respectively. As illustrated, logical grouping 802 can include a component for providing access to at least one API database 810, as well as a component for uploading a received API onto the API database 812. Logical grouping 802 can also include a component for parsing an API request for the received API to ascertain a developer key, a unique identifier, and a partner identifier 814. Further, logical grouping 802 can include a component for tracking a use of the received API based on at least one of the key, the unique identifier, or the partner identifier 816. Additionally, system 800 can include a memory 820 that retains instructions for executing functions associated with components 810, 812, 814, and 816. While shown as being external to memory 820, it is to be understood that components 810, 812, 814, and 816 can exist within memory 820.

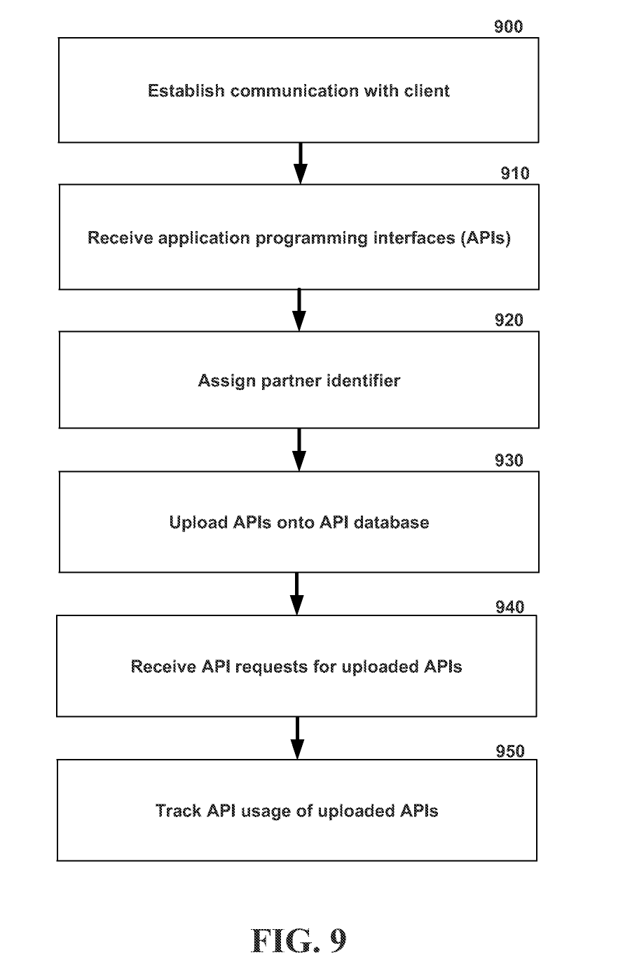

Referring next to FIG. 9, a flow chart illustrating an exemplary method that facilitates uploading APIs according to an embodiment is provided. As illustrated, this method includes a series of acts that may be performed by a computing device according to an aspect of the subject specification. For instance, this method may be implemented by employing a processor to execute computer executable instructions stored on a computer readable storage medium to implement the series of acts. In another embodiment, a computer-readable storage medium comprising code for implementing the series of acts is contemplated.

As illustrated, the method begins by establishing a communication with a client device at act 900. For this particular example, the client may be associated with a partner entity that owns several APIs, which it would like to upload for sale and/or resale (e.g., resold to a user via an ISV). Under such circumstances, the method may thus proceed by receiving a set of APIs from the partner entity at act 910.

Once the APIs are received, a partner identifier is then assigned to the partner entity at act 920. Here, although a single partner identifier may assigned to the entire set of APIs, individual APIs and/or API subsets may be assigned a unique partner identifier. Once the APIs have been assigned their appropriate partner identifiers, they are subsequently uploaded onto an API database at act 930.

In an aspect, APIs stored in the API database are retrievable upon request. The method thus proceeds to act 940 where requests for the uploaded APIs are received. Usage of the uploaded APIs are then tracked at act 950, wherein such tracking facilitates automatic auditing/billing of the uploaded APIs (e.g., on a per use and/or per user basis according to the unique identifiers).

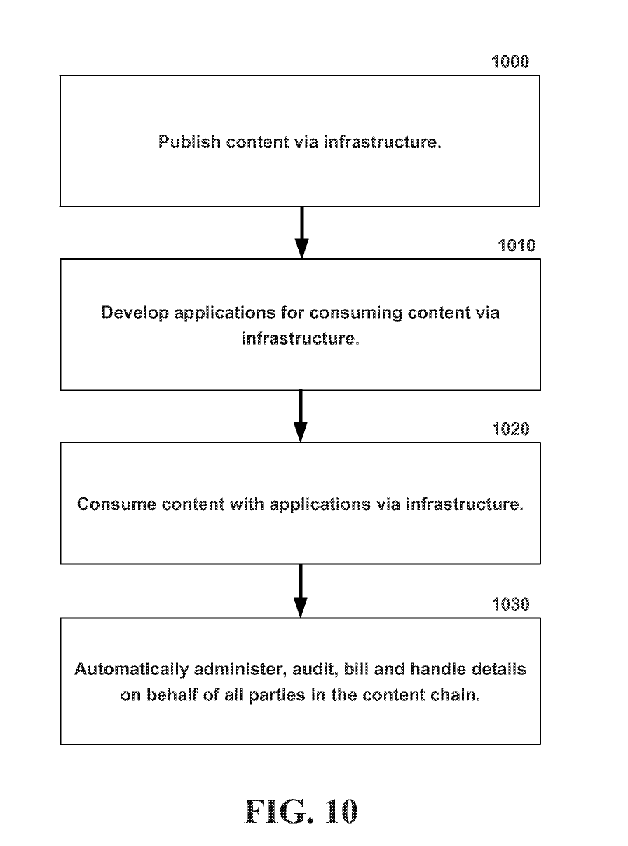

As shown in the flow diagram of FIG. 10, at 1000, described herein are various ways for content owners or publishers to publish data via the infrastructure. At 1010, there are a variety of tools that allow developers to developer applications for consuming the data via the infrastructure. At 1020, consumers or information workers use the applications or can directly query over the data to consume the data. Lastly, the infrastructure provides a rich variety of tools at 1030 that enable automatic administration, auditing, billing, etc. on behalf of all parties in the content chain, enabled by the transaction model.

In this regard, some key parties in the infrastructure include data owners, the application developers/ISVs and the consumers/information workers. In general, data owners are entities who want to charge for data, or who want to provide data for free for other reasons, or enforce other conditions over the data. In turn, application developers/ISVs are entities who want to monetize their application (e.g., through advertising, direct payments, indirect payments, etc.), or provide their application for free for some beneficial reason to such entities. Information workers and consumers are those who can use the raw data, or those who want to use an application provided by the application developers.

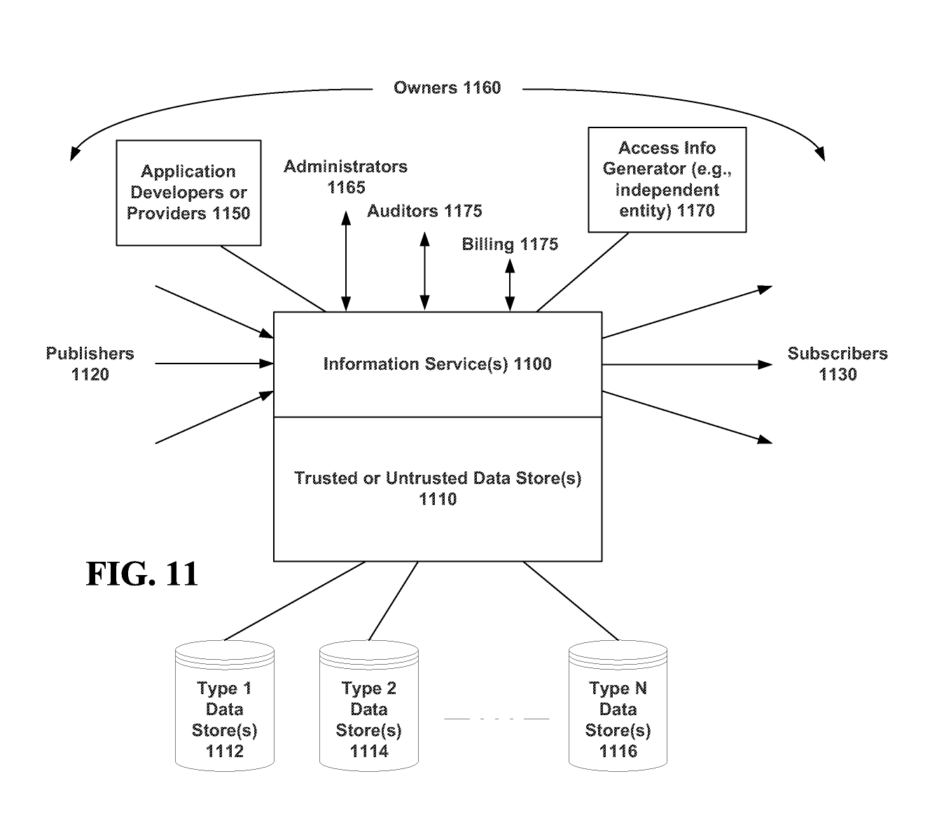

FIG. 11 is a block diagram generally illustrating the various parties that may participate in an ecosystem providing information as a service as described herein. For instance a set of network accessible information services 1100 provide access to a variety of trusted or untrusted data stores 1110, depending on the sensitivity or other characteristics of the data. As shown, thus, what type of data store, 1112, 1114, . . . , 1116 is not so important since the ecosystem supports any kind of data, blob, structured, unstructured, etc. As mentioned, the system includes publishers 1120 that add data to the ecosystem, subscribers 1130 that consume the data and application developers or providers 1150 who help consumption of the data with their applications. An access information generator 1170 can also govern access to the data by various parties through maintaining or enforcing account information, key information, etc. In this respect, content owners 1160 can span any of the roles in that a content owner 1160 can be a publisher 1120, a subscriber 1130 and/or an application developer as well. In one aspect, the common infrastructure for all parties enables administration 1165, auditing 1175, billing 1175 as well as other desired ancillary services to the data transactions occurring across the infrastructure.

In this regard, various embodiments for the user friendly data platform for enabling information as a service from any platform is an infrastructure to enable consumers of data (IWs, developers, ISVs) and consumers of data to transact in a simple, cost effective and convenient manner. The infrastructure democratizes premium (private) and community (public) data in an affordable way to allow IWs to draw insights rapidly, and allows developers to build innovative apps using multiple sources of data in a creative manner and enables developers to monetize their efforts on any platform. For instance, the infrastructure supports Pay Per Use as well as Subscription Pricing for Content, Pay for Content (“retail price”—set by content owner), Pay Data Fee (“Shipping and Handling”) and BW, and further supports Data fees as a brokerage fee on a per-logical transaction basis (per report, per API, per download, etc.).

For Information Workers (e.g., Office, SQL Server, Dynamics users), the infrastructure supports subscriptions to allow for future EA integration as well as predictable spend requirements (as well as caching to support on and off-premise BI as well as “HPC” workloads). Thus, alternatives include content priced per-user per-month; which may or may not bundle to deliver content packs or per-transaction pricing, e.g., allowing cloud reporting / business intelligence on-demand pricing to eliminate the need to move large amounts of data while allowing per-usage pricing, or vertical apps via report galleries.

For content providers (any data type; any cloud), using any platform, the infrastructure becomes a value proposition to incent sales within any particular desired platform; auto-scaling, higher level SLA possibilities at no additional cost. For some non-limiting examples, data can be secure and associated data in the following domains: Location aware services & data, Commercial and residential real estate, Financial data and services, etc. A non-limiting scenario may include delivery of data to top 30 non-governmental organization (NGO) datasets. In addition, the infrastructure may include the ability to showcase BI & visualization through “Bing for information as a service”, HPC, etc. Vertical application opportunities exist as well.

In one non-limiting embodiment, the data brokerage can be analogized to conventional brick and mortar strategies: For instance, capacity can be represented as shelf space (e.g., a mix of structured and unstructured/blob data), cost of goods (COGS) can be represented as square footage, (SA, platform dependency, bandwidth) and content can be represented as merchandise (e.g., optimize content providers to cover COGS, maximize profits from IWs and developers). In various embodiments, an onboarding process can be implemented with quality bars for data and services, as well as accommodation of service level agreements (SLAs).

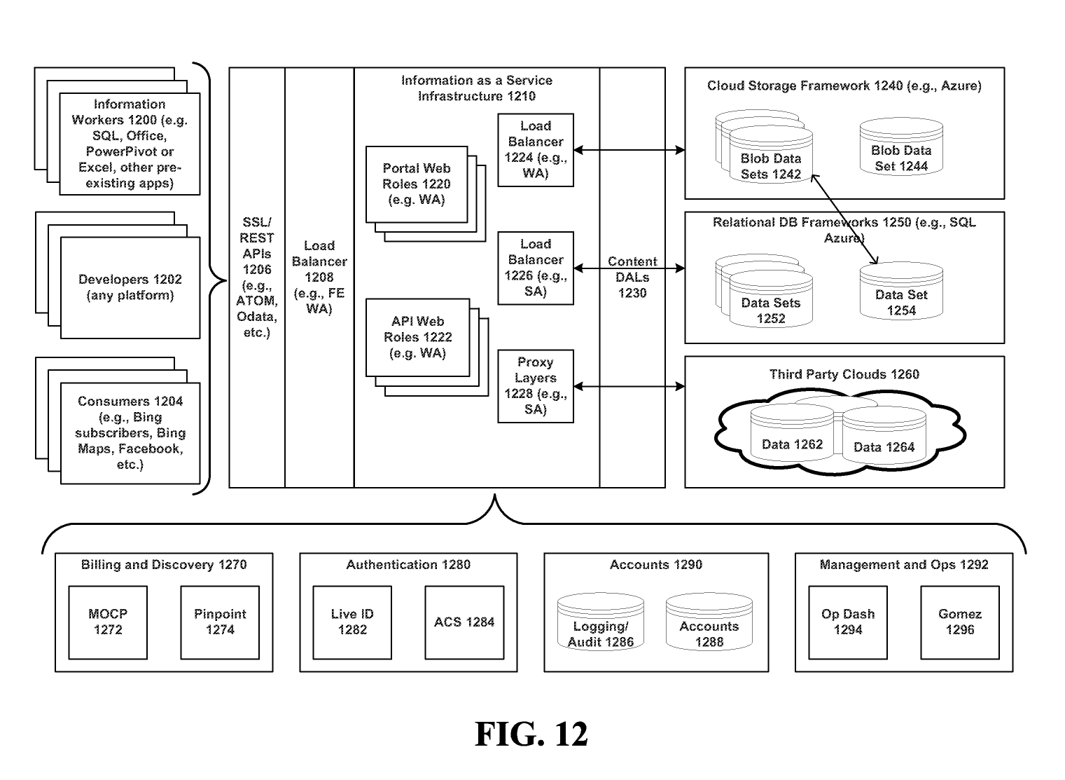

FIG. 12 is an exemplary non-limiting implementation of the infrastructure 1210 for information as a service as described above according to one or more features. At the interaction side are information workers 1200, developers 1202 and consumers 1204 who can communicate with the infrastructure via SSL/REST based APIs 1206. A load balancer 1208 can be used to help steer traffic in an optimal way. In this regard, the input is routed to portal web roles 1220 or API web roles 1222. From the infrastructure 1210 to the data side is additional load balancing 1224 or 1226 (e.g., WA or SA) for access to blob data sets 1242, or blob data set 1255 of cloud storage framework 1240, or to data sets 1252 or data set 1254 of relational database frameworks 1250. Proxy layers 1228 can be used to access data 1262 or data 1264 of third party clouds 1260. Content data abstract layers (DALs) 1230 can be used to access content, where applicable. In this regard, there can be duplication or overlap of data sets across different types of storage, e.g., the same data might be represented as blob data and as structured data, e.g., SQL.

As supplemental services to the data, billing and discovery services 1270 can include online billing 1272 (e.g., MOCP) or discovery services 1274 (e.g., pinpoint) and authentication services 1280 can include credentials management 1282 (e.g., Live ID) or content authentication 1284, e.g., authenticated content services (ACS). Accounts services 1290 can include logging/audit services 1286 or account management 1288. Management and operations services 1292 can include an operations dashboard service 1294 and network operations service 1296, e.g., Gomez.

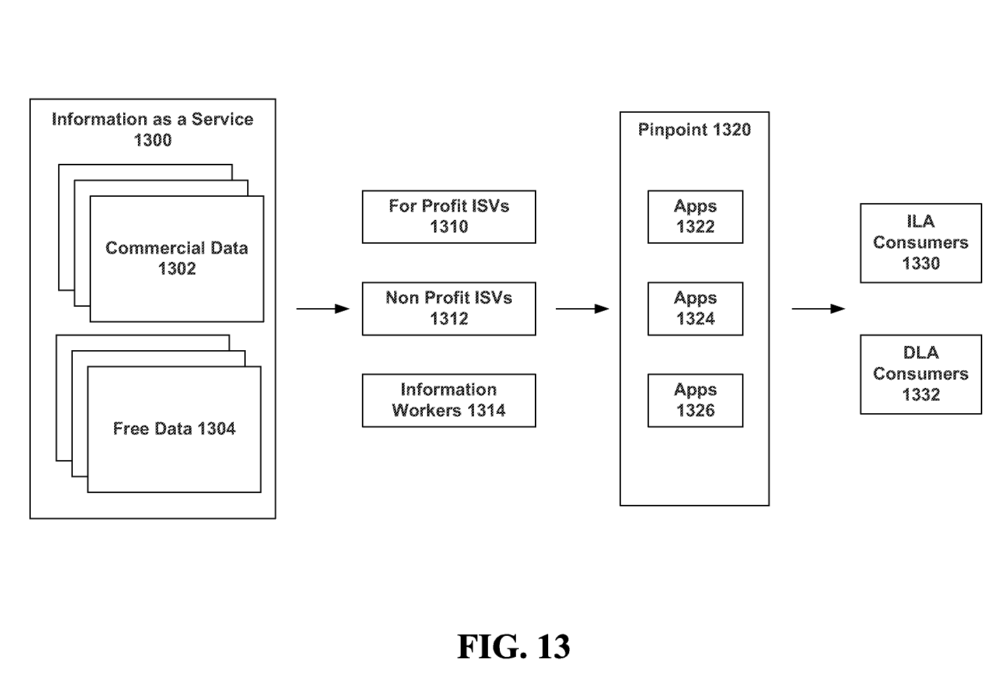

FIG. 13 is a block diagram illustrating an exemplary end to end flow from data to consumers of the data in accordance with one or more embodiments of the general infrastructure for enabling information as a service. For instance, information as a service 1300 can include commercial data 1302 and free data 1304, which can be of interest to various for profit developers 1310, nonprofit developers 1312 with non-profit motives and other information workers 1314 who are interested in consuming the data generally for productive goals. These entities can use discovery services 1320 to determine what applications 1322, 1324, . . . , 1326 may be of interest to them, and to ultimately transmit the data to ILA consumers 1330 and DLA consumers 1332 alike.

### Exemplary Networked and Distributed Environments

One of ordinary skill in the art can appreciate that the various embodiments of methods and devices for an infrastructure for information as a service from any platform and related embodiments described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

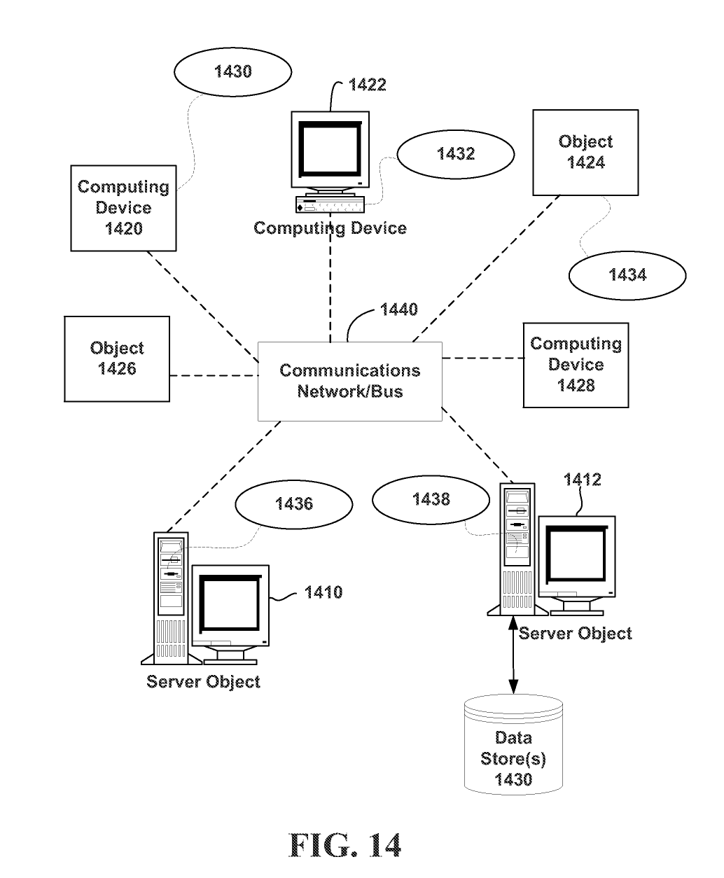

FIG. 14 provides a non-limiting schematic diagram of an exemplary networked or distributed computing environment. The distributed computing environment comprises computing objects 1410, 1412, etc. and computing objects or devices 1420, 1422, 1424, 1426, 1428, etc., which may include programs, methods, data stores, programmable logic, etc., as represented by applications 1430, 1432, 1434, 1436, 1438. It can be appreciated that objects 1410, 1412, etc. and computing objects or devices 1420, 1422, 1424, 1426, 1428, etc. may comprise different devices, such as PDAs, audio/video devices, mobile phones, MP3 players, laptops, etc.

Each object 1410, 1412, etc. and computing objects or devices 1420, 1422, 1424, 1426, 1428, etc. can communicate with one or more other objects 1410, 1412, etc. and computing objects or devices 1420, 1422, 1424, 1426, 1428, etc. by way of the communications network 1440, either directly or indirectly. Even though illustrated as a single element in FIG. 14, network 1440 may comprise other computing objects and computing devices that provide services to the system of FIG. 14, and/or may represent multiple interconnected networks, which are not shown. Each object 1410, 1412, etc. or 1420, 1422, 1424, 1426, 1428, etc. can also contain an application, such as applications 1430, 1432, 1434, 1436, 1438, that might make use of an API, or other object, software, firmware and/or hardware, suitable for communication with or implementation of an infrastructure for information as a service from any platform as provided in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 14, as a non-limiting example, computers 1420, 1422, 1424, 1426, 1428, etc. can be thought of as clients and computers 1410, 1412, etc. can be thought of as servers where servers 1410, 1412, etc. provide data services, such as receiving data from client computers 1420, 1422, 1424, 1426, 1428, etc., storing of data, processing of data, transmitting data to client computers 1420, 1422, 1424, 1426, 1428, etc., although any computer can be considered a client, a server, or both, depending on the circumstances. Any of these computing devices may be processing data, or requesting services or tasks that may implicate an infrastructure for information as a service from any platform and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 1440 is the Internet, for example, the servers 1410, 1412, etc. can be Web servers with which the clients 1420, 1422, 1424, 1426, 1428, etc. communicate via any of a number of known protocols, such as HTTP. Servers 1410, 1412, etc. may also serve as clients 1420, 1422, 1424, 1426, 1428, etc., as may be characteristic of a distributed computing environment.

### Exemplary Computing Device

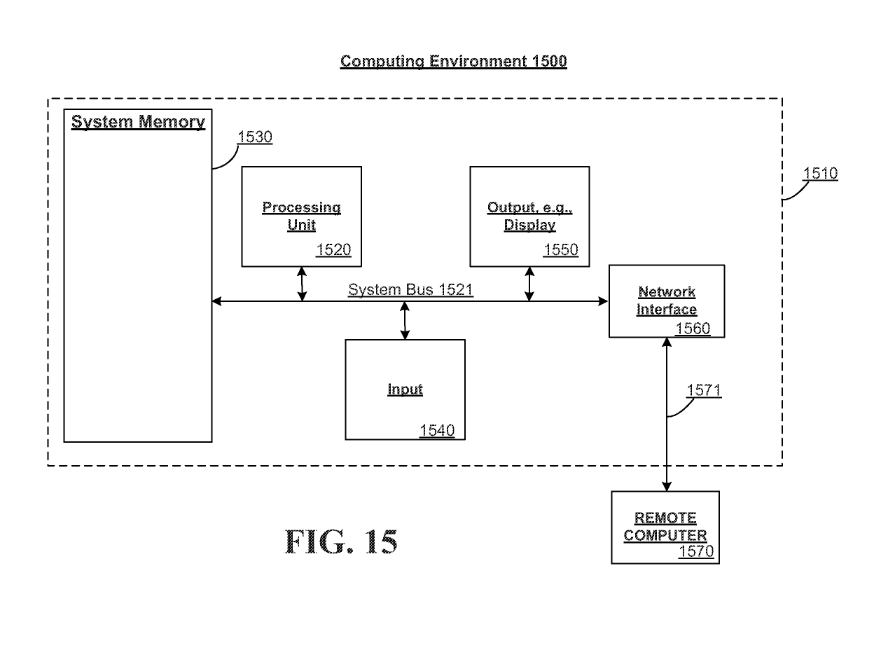

As mentioned, various embodiments described herein apply to any device wherein it may be desirable to implement one or pieces of an infrastructure for information as a service from any platform. It should be understood, therefore, that handheld, portable and other computing devices and computing objects of all kinds are contemplated for use in connection with the various embodiments described herein, i.e., anywhere that a device may provide some functionality in connection with an infrastructure for information as a service from any platform. Accordingly, the below general purpose remote computer described below in FIG. 15 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer-executable instructions, such as program modules, being executed by one or more computers, such as client workstations, servers or other devices. Those skilled in the art will appreciate that network interactions may be practiced with a variety of computer system configurations and protocols.

FIG. 15 thus illustrates an example of a suitable computing system environment 1500 in which one or more of the embodiments may be implemented, although as made clear above, the computing system environment 1500 is only one example of a suitable computing environment and is not intended to suggest any limitation as to the scope of use or functionality of any of the embodiments. Neither should the computing environment 1500 be interpreted as having any dependency or requirement relating to any one or combination of components illustrated in the exemplary operating environment 1500.

With reference to FIG. 15, an exemplary remote device for implementing one or more embodiments herein can include a general purpose computing device in the form of a handheld computer 1510. Components of handheld computer 1510 may include, but are not limited to, a processing unit 1520, a system memory 1530, and a system bus 1521 that couples various system components including the system memory to the processing unit 1520.

Computer 1510 typically includes a variety of computer readable media and can be any available media that can be accessed by computer 1510. The system memory 1530 may include computer storage media in the form of volatile and/or nonvolatile memory such as read only memory (ROM) and/or random access memory (RAM). By way of example, and not limitation, memory 1530 may also include an operating system, application programs, other program modules, and program data.

A user may enter commands and information into the computer 1510 through input devices 1540 A monitor or other type of display device is also connected to the system bus 1521 via an interface, such as output interface 1550. In addition to a monitor, computers may also include other peripheral output devices such as speakers and a printer, which may be connected through output interface 1550.

The computer 1510 may operate in a networked or distributed environment using logical connections to one or more other remote computers, such as remote computer 1570. The remote computer 1570 may be a personal computer, a server, a router, a network PC, a peer device or other common network node, or any other remote media consumption or transmission device, and may include any or all of the elements described above relative to the computer 1510. The logical connections depicted in FIG. 15 include a network 1571, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and advertising architectures, the underlying concepts may be applied to any network system and any computing device or system in which it is desirable to publish, build applications for or consume data in connection with interactions with a cloud or network service.

There are multiple ways of implementing one or more of the embodiments described herein, e.g., an appropriate API, tool kit, driver code, operating system, control, standalone or downloadable software object, etc. which enables applications and services to use the infrastructure for information as a service from any platform. Embodiments may be contemplated from the standpoint of an API (or other software object), as well as from a software or hardware object that facilitates provision of an infrastructure for information as a service from any platform in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists, or vice versa. Similarly, where a method is practiced, a corresponding device can be provided having storage and at least one processor configured to practice that method via one or more components.

While the various embodiments have been described in connection with the preferred embodiments of the various figures, it is to be understood that other similar embodiments may be used or modifications and additions may be made to the described embodiment for performing the same function without deviating there from. Still further, one or more aspects of the above described embodiments may be implemented in or across a plurality of processing chips or devices, and storage may similarly be affected across a plurality of devices. Therefore, the present invention should not be limited to any single embodiment, but rather should be construed in breadth and scope in accordance with the appended claims.

What is claimed is:

1. An apparatus configured to facilitate providing information as a service via web services, the apparatus comprising:
a processor configured to execute computer executable components stored in memory, the components including:
an interface component configured to facilitate access to at least one application programming interface (API) database;
a parsing component configured to parse a request for a requested API, wherein the request facilitates a processing of data provided by at least one content provider, and wherein the request includes a key associated with a developer of the requested API and a unique identifier associated with a user of the requested API; and
a tracking component configured to track a use of the requested API based on at least one of the key or the unique identifier.

2. The apparatus of claim 1, further comprising a generation component configured to generate the request based on a selection of the requested API.

3. The apparatus of claim 2, the interface component configured to display a plurality of selectable APIs stored in the at least one API database, the requested API included in the plurality of selectable APIs.

4. The apparatus of claim 3, the interface component configured to facilitate a search of the at least one API database, the plurality of selectable APIs corresponding to results of the search.

5. The apparatus of claim 4, the search based on an input, the input identifying at least one of a desired operation, a desired content provider, or a desired content type.

6. The apparatus of claim 1, the interface component configured to upload an external API onto the at least one API database.

7. The apparatus of claim 1, the use corresponding to a multi-seat use of the requested API, the parsing component configured to extract multiple unique identifiers from the requested API, wherein the multiple unique identifiers identify multiple users associated with the multi-seat use.

8. The apparatus of claim 1, further comprising an audit component configured to automatically audit a usage history of at least one of the plurality of APIs.

9. The apparatus of claim 1, further comprising a billing component configured to automatically bill an external entity based on a usage history of at least one of the plurality of APIs.

10. The apparatus of claim 1, the request further including a partner identifier associated with an affiliate of the requested API, wherein the tracking component is further configured to track the use of the requested API based on the partner identifier.

11. A method that facilitates providing information as a service via web services, including:
employing a processor to execute computer executable instructions stored on a computer readable storage medium to implement a series of acts including:
providing access to at least one application programming interface (API) database;
receiving a request identifying a requested API, the request facilitating a processing of data provided by at least one content provider;
parsing the request to ascertain a key associated with a developer of the requested API and a unique identifier associated with a user of the requested API; and
tracking a use of the requested API based on at least one of the key or the unique identifier.

12. The method of claim 11, further comprising automatically auditing a usage history of at least one API stored in the at least one API database.

13. The method of claim 11, further comprising automatically billing an external entity based on a usage history of at least one API stored in the at least one API database.

14. The method of claim 11, the parsing comprising extracting multiple unique identifiers from the requested API, wherein the multiple unique identifiers identify multiple users associated with a multi-seat use of the requested API.

15. The method of claim 11, the request further including a partner identifier associated with an affiliate of the requested API, wherein the tracking further comprises tracking the use of the requested API based on the partner identifier.

16. The method of claim 15, further comprising inserting at least one of the key, the unique identifier, or the partner identifier into the request.

17. A method that facilitates providing information as a service via web services, including:
employing a processor to execute computer executable instructions stored on a computer readable storage medium to implement a series of acts including:
providing access to at least one application programming interface (API) database;
uploading a received API onto the API database, the received API facilitating a processing of data provided by at least one content provider;
parsing a request for the received API to ascertain a key associated with a developer of the received API and a unique identifier associated with a user of the received API; and
tracking a use of the received API based on at least one of the key or the unique identifier.

18. The method of claim 17, further comprising automatically auditing a usage history of the requested API.

19. The method of claim 17, the parsing comprising extracting multiple unique identifiers from the requested API, wherein the multiple unique identifiers identify multiple users associated with a multi-seat use of the requested API.

20. The method of claim 17, the parsing comprising parsing the request to ascertain a partner identifier associated with an affiliate of the requested API, wherein the tracking further comprises tracking the use of the requested API based on the partner identifier.
